(19) United States
(12) Patent Application Publication
(10) Pub. No.: US 2005/0104351 A1
(43) Pub. Date: May 19, 2005

(54) Gas bag

(75) Inventor: Christian Lorenz, Leidersbach (DE)

Correspondence Address: THOMAS L. TAROLLI;TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems Gmbh

(21) Appl. No.: 10/983,460

(22) Filed: Nov. 8, 2004

(30) Foreign Application Priority Data
Nov. 14, 2003 (DE) 203 17 614.6

(51) Int. Cl. B60R 21/16

(52) U.S. Cl. 280/743.1; 280/731

(57) ABSTRACT

A gas bag has an exterior wall having a front side that, in the inflated state, faces the occupant, a rear side and a circumferential side and at least one inflation opening. The inflated gas bag has a deep, channel-shaped indentation that extends toward the inflation opening. The indentation is not filled with compressed gas and at least one annular chamber to be filled with compressed gas is formed between the indentation and the circumferential side. At a distance from the front-side end of the indentation at least one flexible closure part is provided, which is connected in sections to the exterior wall. The closure part, when the gas bag is fully inflated, closes the indentation at least partially and, when the gas bag is folded, can be displaced in order to expose the indentation.

### FIELD OF THE INVENTION

The present invention relates to a gas bag.

### BACKGROUND OF THE INVENTION

So-called annular-chamber gas bags have a deep, central indentation, starting from outside, usually from the front side, the indentation not being filled with compressed gas. A gas bag of this known type is shown in FIG. 6. This indentation is usually formed by one part of the exterior wall being turned to the inside and its deepest point, in the inflated state, being prevented from having free motion to the outside. “Free motion” does not necessarily mean that this part of the gas bag is prevented from carrying out any motion. It would be entirely conceivable to provide this part of the gas bag with a short limiting strap, which, during deployment, would permit a small motion in the direction of the occupant, but then would restrain the segment of the exterior wall that is connected to it, so that the deep, channel-shaped indentation would be produced.

It is known to provide an additional fabric layer on the front side of the exterior wall, the fabric layer at its edge being attached in sections to the exterior wall by a U-shaped seam. The fabric layer can be displaced at its open side, for folding the gas bag, such that the indentation is open, so that, before inflation, a fixed central part of the module covering protrudes out of the indentation. During deployment, the gas bag slides along this fixed central part of the covering. Then, the additional fabric layer can slide over the indentation, specifically in front of the indentation (see FIG. 6), so that the occupant on the front side encounters a closed restraining surface, without an indentation.

### BRIEF SUMMARY OF THE INVENTION

It is an object of the present invention to provide an annular gas bag, which is distinguished by a small packing volume.

This is achieved in a gas bag comprising an exterior wall having a front side that, in the inflated state, faces the occupant, a rear side and a circumferential side and at least one inflation opening. The inflated gas bag has a deep, channel-shaped indentation that extends toward the inflation opening. The indentation is not filled with compressed gas and at least one annular chamber to be filled with compressed gas is formed between the indentation and the circumferential side. At a distance from the front-side end of the indentation at least one flexible closure part is provided, which is connected in sections to the exterior wall. The closure part, when the gas bag is fully inflated, closes the indentation at least partially and, when the gas bag is folded, can be displaced in order to expose the indentation. Whereas in the prior art the fabric layer provided on the front side completely covers the indentation to the outside over a large surface, provision is made in the present invention that the closure part is situated not in front of the covering, but in the deep channel that is formed by the indentation. Because the indentation greatly widens to the outside towards the front side, the closure part must have a small surface-area extension, if it is positioned in the channel itself. Associated with the smaller surface-area extension of the closure part is a smaller packing volume. Furthermore, in the vicinity of the front side of the gas bag no seams are provided, which are specially carried out or, additionally, sealed to assure a certain impermeability to gas. A further advantage of the present invention lies in the fact that the upper part of the indentation, as seen from the occupant, is still open before it is at least partly (as seen from the occupant) or completely closed by the closure part. This means that the restraining surface which the occupant encounters is not a plane but rather, towards the center, slopes toward the interior of the gas bag. As a result of this geometry, the occupant within certain limits can further be optimally positioned in response to being immersed in the gas bag, the closure part nevertheless preventing too deep an immersion.

In the inflated state of the gas bag, the closure part should lie in the outermost third of the indentation. This means that the depth of the indentation is determined from the front side, and the closure part, in this context, must be situated in the outermost third, i.e., the third that is closest to the occupant. As a result of the closure part, the entire indentation can be kept small even in cross section, because, via the closure part, segments of the gas bag wall bordering on the indentation, that are situated opposite each other, can be maintained at a fixed distance from each other.

On folding of the gas bag the closure part can preferably be displaced to expose the (later) indentation. During the displacement an inner section of the indentation is freed, which is defined, in relation to the inflated state, by a channel section extending from the closure part to the back side.

For this purpose the closure part can be arranged such that a free edge thereof is displaceable in a radial direction in a non- or not much inflated state of the gas bag. A displacement of the closure part can also be intended in a not much inflated state like one the gas bag passes during its unfolding, to bring the closure part into its position taken up in the fully inflated state of the gas bag.

Preferably, the closure part is a separate fabric layer, specifically, e.g., made of an uncoated gas bag fabric. Of course straps, foils, or lattice structures are also conceivable, which can provide the aforementioned advantages.

Usually, the exterior wall of the gas bag is made of a plurality of fabric parts. The closure part is attached to the exterior wall not by seams that are specifically provided for it, but rather by using a seam that is already present and that joins fabric parts of the exterior wall to each other.

A seam of this type is preferably the one that joins a fabric part constituting the front side and the beginning of the indentation to a fabric part constituting the adjacent segment of the indentation. In this case, the closure part is situated between the two aforementioned fabric parts, so that, using the same seam, three parts are joined to each other.

Preferably, a plurality of closure parts is provided that are situated next to each other, specifically such that a geometry of all closure parts is formed that is symmetrical from the point of view of the occupant. Preferably, in the inflated state, the closure parts overlap each other partially, in order to close the indentation at least partially.

In this connection, the concept “to close” should not be understood to mean that the closure part divides the indentation into segments that are separate from each other in terms of gas flow. Rather, the meaning is that, from the point of view of looking from outside into the indentation, the indentation in the cross section that results is not entirely open down to the base of the indentation.

According to one embodiment, at least three closure parts are provided.

The closure parts are arranged next to each other on the circumference of the indentation in the area of their attachment and partly overlap each other.

The closure parts, given appropriate positioning and design, may present the appearance of a photo lens aperture that is at least nearly closed.

Segments of a circular disks, especially semicircular disks or sickle-shaped closure parts, have proven to be advantageous as specific shapes of the closure parts.

### BRIEF DESCRIPTION OF THE DRAWINGS

In the drawings:

FIG. 1 shows a longitudinal sectional view of a gas bag according to the present invention in the fully inflated state,

FIG. 2 shows an enlarged view of the area in FIG. 1 that is designated as X,

FIG. 3a through FIG. 3d show top views of different embodiments of the closure parts that can be used in the gas bag according to the present invention,

FIG. 4a through FIG. 4d show top views of different variants of a closure part that can be used in the present invention,

FIG. 5a through FIG. 5e show successive phases of the arrangement of the closure parts during inflation of the gas bag, seen from above looking into the indentation, and

FIG. 6 shows a longitudinal sectional view of a gas bag according to the prior related art, in the fully inflated state.

### DETAILED DESCRIPTION OF PREFERRED EMBODIMENTS

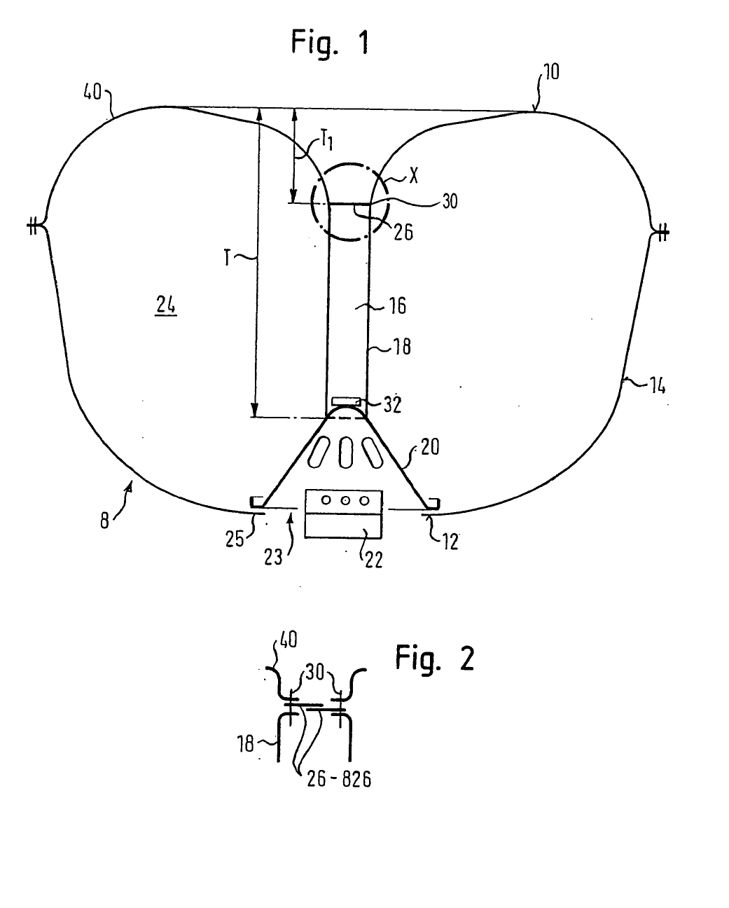

In FIG. 1, a driver gas bag module with a driver gas bag 8 in its fully inflated state is depicted. Gas bag 8 has an exterior wall, which defines a front side 10, a rear side 12, and a circumferential side 14, and which is made up of a plurality of fabric parts that are sewn to each other, as shall be explained below in greater detail. Front side 10 faces the occupant and has a deep, channel-shaped indentation 16, which widens towards front side 10 and is delimited by the exterior wall. Indentation 16 is formed in that one part of the exterior wall is prevented from an unhindered motion during inflation. This is achieved in that a fabric part 18 at its lower end (the deepest point of the indentation) is attached to a diffusor cage 20, in which a gas generator 22 sits. In the area of gas generator 22, the gas bag has an inflation opening 23, which is surrounded by a so-called inflation mouth 25 of the gas bag. Gas generator 22 partially protrudes into the inflation opening 23. Indentation 16 extends from front side 10 toward inflation opening 23.

The exterior wall delimits an annular chamber 24 that is inflated by the compressed gas produced in gas generator 22, the annular chamber at its interior side being delimited by indentation 16. In indentation 16 itself, no compressed gas is intentionally introduced, rather indentation 16 is spanned by annular chanber 24.

Indentation 16 has a depth T, which is measured from the uppermost point of front side 10 in FIG. 1 (the point that is furthest from the plane that is spanned by injection mouth 25) to the deepest point of indentation 16. Indentation 16 usually begins at the uppermost point of front side 10.

In the channel, at a significant distance from the front-side end of indentation 16, a plurality of flexible closure parts 26 made of fabric material are joined in sections to the exterior wall. Closure parts 26, as can be seen from FIG. 1, are situated approximately in the area of the lower end of the outermost third of the indentation at depth T₁ (i.e., 3×T₁ equals roughly T). Indentation 16 runs below closure parts 26 in roughly cylindrical fashion, basically without narrowing or widening.

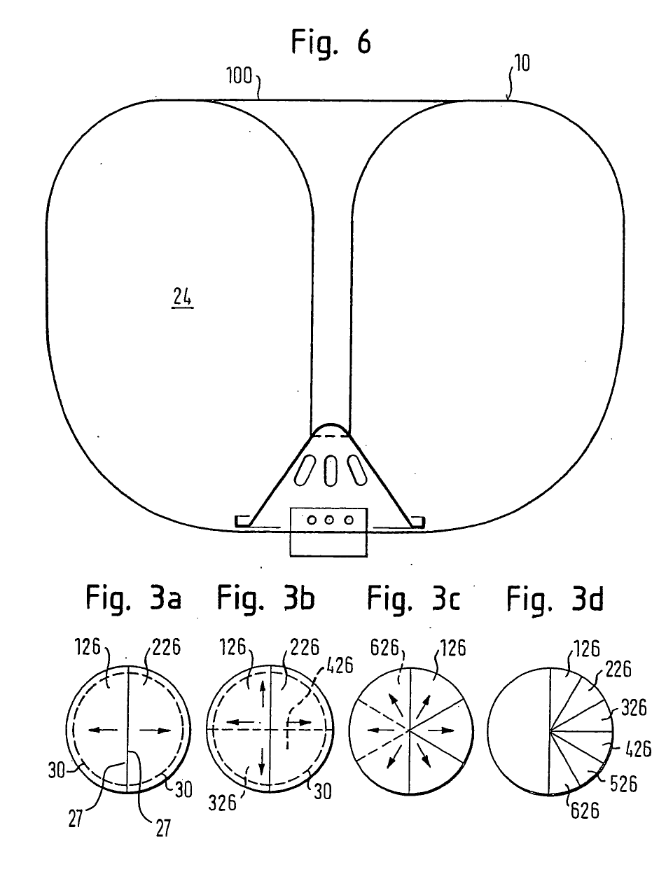

Closure parts 26 not only keep the segments of the exterior wall, which are approximately facing each other, at a constant distance in the radial direction, but they also generally assure that indentation 16, as seen from above, is substantially closed in the area of closure parts 26. In FIGS. 3a through 3d, different variants and arrangements of the closure parts are shown.

In FIGS. 3a two segments of a circular disk 126, 226, precisely semicircular disks, are arranged so as to be next to each other, such that together they can complement each other to one closed disk when gas bag 8 is inflated. Each closure part 126, 226, is joined in sections to the exterior wall of gas bag 8 by a seam 30, specifically on its exterior curved edge. To fold gas bag 8, closure parts 126, 226, can be pulled to the outside in the center, i.e. at their free edges 27, as depicted by the arrows, so that they expose indentation 16. The displacement towards the outside corresponds substantially to a movement in radial direction. This has the advantage that a central segment 32 of the covering cap can remain permanently attached to diffusor cage 20.

In the embodiment according to FIG. 3b, four partially overlapping closure parts 126 through 426 are arranged offset by 90° with respect to each other. Closure parts 126 through 426 are therefore circumferentially positioned at a uniform distance from each other, and they uniformly overlap each other. For folding, they are pulled to the outside (see arrows), so that indentation 16 is once again exposed. Here as well, only one seam 30 is provided, which attaches all closure parts 126 through 426 to the exterior wall. Closure parts 126 through 426, apart from seam 30, are not directly joined to each other.

In the embodiment according to FIG. 3c, six closure parts 126 through 626 are arranged in a fan-like fashion, partially on top of each other, and correspondingly partially overlapping each other on the circumference, in the embodiment according to FIG. 3d as many as 12 closure parts being provided.

Closure parts 26 through 626 act like a photo lens aperture, which is closed tighter as the inflated state of gas bag 8 increases, such as can be seen on the basis of FIGS. 5a through 5e.

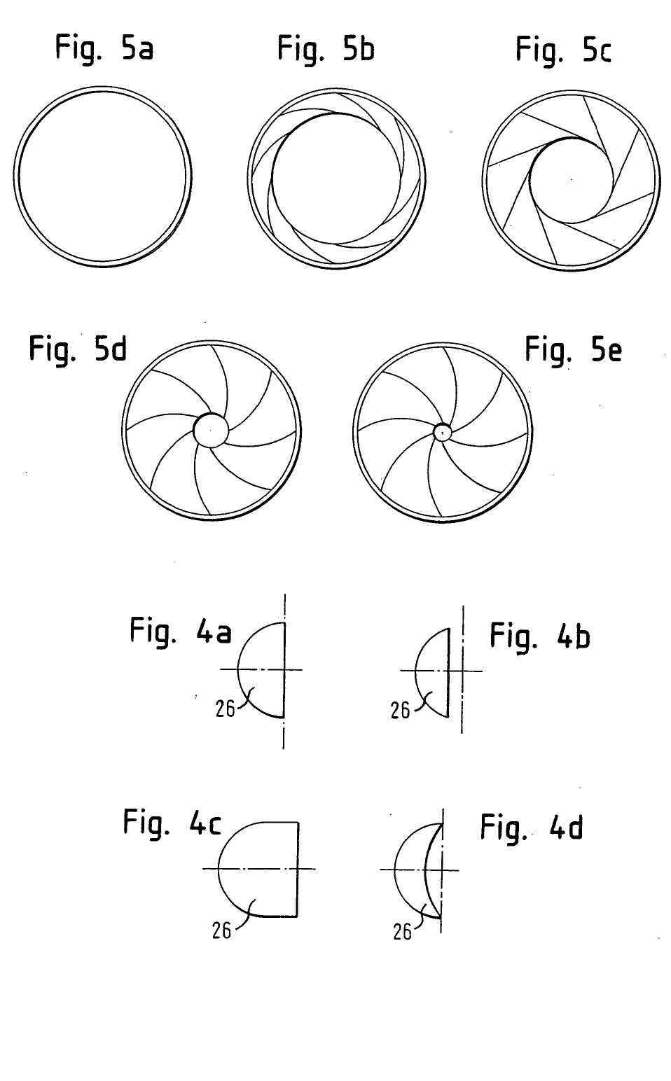

The shapes of individual closure parts 26 through 626 that can be used, are manifold. In FIG. 4a, a closure part 26 is depicted, which has the shape of a semicircular disk.

In FIG. 4b, closure part 26 is a segment of a circle, having a smaller surface area than the semicircular disk.

In FIG. 4c, closure part 26 depicted in FIG. 4a is extended by a rectangular segment, and in FIG. 4d, closure part 26 is sickle-shaped. All of the closure part shapes can be used in any combination with the arrangements according to FIGS. 3a-d.

Advantageously, for attaching closure parts 26 to the exterior wall, no additional seams are provided. Rather, closure parts 26 through 626 are positioned between two fabric layers, which are joined to each other anyway at a closed circumferential seam 30. For this purpose, reference is made to FIGS. 1 and 2, in which a fabric part 40, defining the front side, is joined by seam 30 to a fabric part 18 defining the lower part of indentation 16. Closure parts 26 through 626 are arranged between two fabric layers 40, 18.

FIG. 6 shows the prior art, which the present invention uses as a point of departure. Here, the difference with respect to the position of the closure parts can be clearly discerned. According to FIG. 6, a large-area fabric part 100 on front side 10 is attached to the exterior wall in the area of the uppermost section of front side 10, so that for the occupant a planar restraining surface is made available, whereas the restraining surface according to FIG. 1 is also formed by the uppermost part of indentation 16, as a result of which the occupant is very well fixed in position laterally.

1. A gas bag, comprising:
an exterior wall having a front side (10) that, in an inflated state, faces an occupant, a rear side (12), and a circumferential side (14),
at least one inflation opening (23),
said gas bag, in said inflated state having a deep, channel-shaped indentation (16) extending toward said inflation opening (23), said indentation (16) not being filled with compressed gas, and
at least one annular chamber (24), to be filled with compressed gas, being formed between said indentation (16) and said circumferential side (14),
characterized in that at a distance from a front-side end of said indentation (26), at least one flexible closure part (26-626) is provided, which is connected in sections to said exterior wall, said closure part, when said gas bag is fully inflated, at least partially closing said indentation and, when said gas bag is folded, being able to be displaced in order to expose said indentation (16).

2. The gas bag as recited in claim 1, wherein said closure part (26-626) is arranged such that a free edge (27) of said closure part (26-626) is displaceable in a radial direction in a non-inflated state of said gas bag (8).

3. The gas bag as recited in claim 1, wherein said closure part (26-626), in said inflated state of said gas bag, is situated in an outermost third of said indentation (16).

4. The gas bag as recited in claim 1, wherein said closure part (26-626) is a separate fabric layer.

5. The gas bag as recited in claim 1, wherein said exterior wall is made up of a plurality of fabric parts (40, 18), and said closure part (26-626) is attached to these fabric parts (40, 18) by a seam (30) that joins fabric parts (40, 18) of said exterior wall to each other.

6. The gas bag as recited in claim 5, wherein one fabric part (40) forms said front side (10) and said beginning of said indentation (16), and one fabric part (18) forms a section of said indentation (16) that is adjacent thereto, and said closure part (26-626) is sewed in, between these fabric parts (40, 18).

7. The gas bag as recited in claim 1, wherein a plurality of closure parts (26-626) are provided that are situated next to each other and that, in said inflated state of said gas bag, partially overlap each other in order to at least partially close said indentation (16).

8. The gas bag as recited in claim 1, wherein at least three closure parts (26-626) are provided.

9. The gas bag as recited in claim 1, wherein said closure parts (26-626) are arranged on a circumference of said indentation (16) so as to be next to each other and, in this context, to overlap each other.

10. The gas bag as recited in claim 1, wherein a plurality of closure parts is provided, taking on the shape of a closed photo lens aperture in said inflated state of said gas bag.

11. The gas bag as recited in claim 1, wherein said at least one closure part (26-626) has a shape of a segment of circular disk.

12. The gas bag as recited in claim 1, wherein said at least one closure part (26-626) is configures to be sickle-shaped.
